(19) United States
(12) Patent Application Publication
(10) Pub. No.: US 2019/0156262 A1
(43) Pub. Date: May 23, 2019

(54) SYSTEM AND METHOD FOR EVALUATING A CORPORATE STRATEGY IN A DATA NETWORK

(71) Applicants: ASHA PRASUNA, MUMBAI (IN); SIVA KUMAR NALINI VENKATA SINGARAJU, MUMBAI (IN); PARTHASARATHY SRINIVASA VANKIPURAM, MUMBAI (IN)

(72) Inventors: ASHA PRASUNA, MUMBAI (IN); SIVA KUMAR NALINI VENKATA SINGARAJU, MUMBAI (IN); PARTHASARATHY SRINIVASA VANKIPURAM, MUMBAI (IN)

(21) Appl. No.: 15/505,084

(22) PCT Filed: Feb. 7, 2017
(86) PCT No.: PCT/IB2017/050651

§ 371 Date: Feb. 18, 2017

(30) Foreign Application Priority Data
Aug. 25, 2016 (IN) 201621028919

(51) Int. Cl. G06Q 10/06

(52) U.S. Cl. CPC G06Q 10/06375; G06Q 10/06393; G06Q 10/0635

(57) ABSTRACT

A system and method for evaluating a corporate strategy in a data network is disclosed. The method includes identifying a set of synergy factors associated to the corporate strategy where the corporate strategy applies to a legal entity. Further, a weight for a synergy factor associated to the legal entity may be evaluated and a score for the corporate strategy may be evaluated based on an estimated weight for each synergy factor. Furthermore, the corporate strategy applicable to the legal entity may be graded based on the evaluated score.

### FIELD OF THE INVENTION

The present invention relates to financial and corporate strategies applicable to legal entities. More specifically, the present invention related to methods and systems employed within a data network to evaluate a probability of success of a corporate strategy applied on a legal entity.

### BACKGROUND OF THE INVENTION

In the field of finance and corporate strategies, Mergers and Acquisition (M&A) has been considered as an imperative corporate strategy to enhance a market share of a product or service of a corporate legal entity, increase research and development (R&D) benefits, improve profitability and revenue, optimize cost, obtain synergies in technology, and improve processes and expand geographical reach.

Existing technologies measure a probability of success of an M&A by parameters such as share price, market capitalization, increase/decrease in sales and revenue, post integration issues and impact on public and culture and technology synchronization. Survey and interviews have been employed to compare aforementioned parameters pre and post the M&A. However, a plurality of changes usually occur during, pre and post M&A. For instance, a change in a leadership team of a target legal entity may result in unexpected results. Further, a data associated with majority of aforementioned parameters may be unavailable prior to the M&A, thereby leaving little scope for an accurate quantitative analysis of the probability of success or a success rate of the M&A. Furthermore there may be less linkage between theoretical prescriptions and practitioner's views.

Hence there is a need for an alternate system and method that measures and identifies gaps in the M&A and predicts the probability of success of the M&A accurately. The alternate system and method should provide an opportunity to effect counter-measures to increase the success rate based on identified gaps. Thus an alternate solution for evaluating a financial strategy such as the M&A in a data network is proposed.

### SUMMARY OF THE INVENTION

A system for evaluating a corporate strategy in a data network is disclosed. According to an example of the present disclosure, the system includes a network server configured to identify a set of legal entities applicable to the corporate strategy. Further the system includes a computing device in communication with the network server where the computing device includes a prediction engine. The prediction engine may identify a set of synergy factors associated to the corporate strategy. Further the prediction engine may estimate a score of each synergy factor associated to a legal entity with respect to the assigned maximum weight of the each synergy factor, wherein the legal entity is selected from the set of legal entities. Furthermore, a score for the corporate strategy applicable to the legal entity may be evaluated based on the estimated score of each synergy factor, and a success rate of the corporate strategy applicable to the legal entity may be determined based on the evaluated score.

To be done on finalizing claims. According to another aspect of the present disclosure, a method for evaluating a corporate strategy in a data network is disclosed. The method includes identifying a set of synergy factors associated to the corporate strategy, wherein the corporate strategy applies to a legal entity. Further a score of each synergy factor associated to the legal entity with respect to the assigned maximum weight of the each synergy factor may be estimated. A score of the corporate strategy applicable to the legal entity based on the estimated score of each synergy factor may be evaluated and a success rate of the corporate strategy applicable to the legal entity may be determined based on the evaluated score.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a schematic diagram of a data network including a computing device and a network server, according to an example of the present disclosure.

FIG. 2 is a flowchart illustrating a method for evaluating a corporate strategy in a data network, according to an example of the present disclosure.

FIG. 3 represents a flowchart illustrating a method for evaluating a corporate strategy according to another example of the present disclosure.

FIG. 4 depicts example block diagram showing a non-transitory computer-readable media to evaluate a corporate strategy.

### DETAILED DESCRIPTION OF THE INVENTION

The present invention provides systems, methods, and computer program product for evaluating a corporate strategy in a data network. Examples referred to herein are for illustrative purposes.

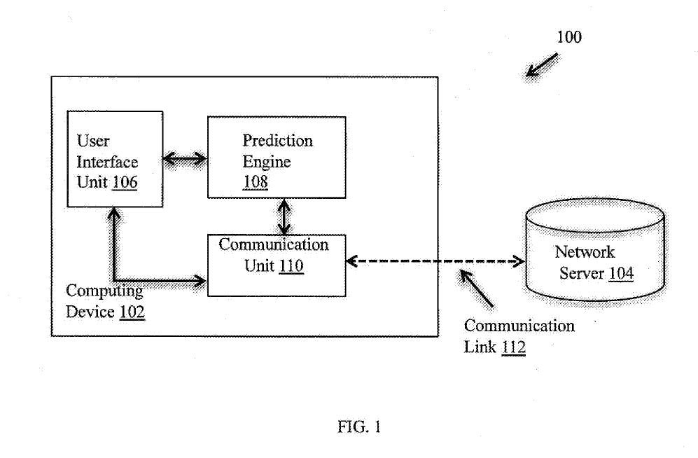

FIG. 1 shows an example data network 100 in which embodiments of the present disclosure may be practiced. The data network 100 includes a computing device 102 in communication with a network server 104 via a communication link 112. The computing device 102, includes a user interface unit 106, a prediction engine 108, and a communication unit 110. The computing device 102 can be a desktop computer, a laptop computer, a tablet computer, an automobile computer, a smart phone, a personal digital assistant, or other computing devices capable of running computer applications, as contemplated by a person having ordinary skill in the art. The network server 104, can be a server or a combination of servers hosted on a cloud storing data relating to a set of legal entities, where a legal entity may be a stock exchange-listed company that belongs to an industry sector. Further, the communications link 112 may be implemented by any medium or mechanism that provides for the exchange of data between the computing device 102 and the network server 104. Examples of communications link 112 may include, without limitation, a network such as a Local Area Network (LAN), Wide Area Network (WAN), Ethernet or the Internet, or one or more terrestrial, satellite or Wireless links.

The network server 104 may refer to one or more servers deployed over a cloud network. An analysis of global, regional and local economic environment maybe done by the network server 104, to identify the set of legal entities or stock exchange-listed companies that belong to various industry or sectors. Further, the network server 104 may store a past performance data, geographical location information, financial data, non-financial data of the set of legal entities. In an instance, financial data may be collated from annual reports or proprietary databases of the set of legal entities accessible over the cloud network. Further, non-financial data may include technology, R&D, patents, employment, wages, salaries and other such data compiled for the set of legal entities.

The user interface unit 106 may include a keyboard, touch screen interface, a display and the like through which a user may communicate with the computing device 102. The user may input a primary legal entity, via the user interface unit 106, for which a corporate strategy needs to be evaluated. For example, the corporate strategy may include a merger and acquisition of the primary legal entity with a legal entity selected from the set of legal entities. The communication unit 110 may communicate via the communication link 112, information including the primary entity for which a corporate strategy needs to be evaluated to the network server 104. The network server 104 may identify the set of legal entities applicable for the corporate strategy with the primary legal entity. The communication unit 110 may retrieve the set of legal entities from the network server 104 and segregate the set of legal entities into a plurality of groups, based on a type and a market capitalization of the legal entity. For example the plurality of groups may include a large cap, a mid cap and a small cap industrial sector. Segregating the set of legal entities may enable account a market size of the legal entity while setting a benchmark score.

The prediction engine 108 may identify a set of synergy factors associated to the corporate strategy. For example, the set of synergy factors may include finance, technology, management, geography, and macro-economic variables. Further, the prediction engine 108 may identify a set of sub-factors for each synergy factor. For example, the sub-factors identified for the finance synergy factor may be Multiple—Enterprise Value divided by Earnings Before Interest, Tax, Depreciation and Amoritization (EV/EBITDA), current profit or loss, deal value, share price, Market Capital (Mcap)—As % of Total M Cap, Sales, Revenue, Customers/clients, Suppliers, and a Share holding Pattern. In another example, the sub-factors identified for the technology synergy factor may include current technology, new technology, adaptability, patent, Research and Development (R&D), expense required, replacement cost, suitability, environment factors, and a life span of technology. In an example, the sub-factors identified for the management parameters synergy factor may include, current leadership, new leadership, strategy sync, compensation sync, process sync, policy integration, and culture sync. In an example the sub-factors identified for the geography synergy factor may include, expansion in existing geography, prospective geography, market share seeking, regulatory incentives seeking, cost synergy, and manpower synergy. In an example the sub-factors identified for the macro-economic variables synergy factor may include, inflation, interest rate, exchange rate, industry prospects, government policies, employment, and standard of living.

Further, the prediction engine 108 may assign a maximum weight to each synergy factor such that a total maximum weight of all the synergy factors may sum up to 100. For example, the Finance Synergy Factor that includes aforementioned seven sub-factors may be assigned a maximum weight of 28, the technology synergy factors that includes aforementioned nine sub-factors may be assigned a maximum weight of 20, the management synergy factor that may include aforementioned seven sub-factors may be assigned a maximum weight of 15, the geography synergy factor that includes five sub-factors may be assigned a maximum weight of 18 and the macro-economic variables that includes aforementioned seven sub-factors may be assigned a maximum weight of 19. Further, a score of each synergy factor associated to the legal entity may be estimated with respect to the assigned maximum weight. Qualitative and quantitative information available from the legal entity such as a performance data, geographical location, financial data, non-financial data and the group associated with the legal entity may be obtained for estimating the score of the each synergy factor.

For example, a maximum weight may be assigned to each sub-factor of the synergy factor. A score of each sub-factor may be estimated with respect to the assigned maximum weight and the quantitative and qualitative information available from the legal entity. For example, sub-factor share price of the finance synergy factor may be assigned a maximum weight of ‘3’, and a score of ‘1’ may be estimated for a legal entity whose share price falls in a bracket of 0 to 20, a score of ‘2’ may be estimated for a legal entity whose share price falls in a bracket of 20 to 50, and a score of ‘3’ may be estimated for a legal entity whose share price falls in a bracket of 50 and above. The score of each sub-factor may be aggregated to obtain the score of each synergy factor.

Further, a score of the corporate strategy applicable to the legal entity may be evaluated based on the estimated score of each synergy factor. The estimated score of each synergy factor may be summed to obtain the score of the corporate strategy applicable to the legal entity. Furthermore, the prediction engine 108 may determine a success rate of the corporate applicable to the legal entity based on the evaluated score. For example, an evaluated score of 71 and above for a legal entity may be mapped to an extremely high success rate, alternatively one may infer that a merger and acquisition of the primary legal entity with such legal entity may result in a successful outcome. Similarly, an evaluated score of 65-70 may be mapped to a high success rate, an evaluated score of 60-64 may be mapped to a medium success rate, an evaluated score of 55-59 may be mapped as an average success rate, and an evaluated score of 50-54 may be mapped as below average success rate, an evaluated score of 45-49 may be interpreted as a corporate strategy where a scope for improvement is needed, and an evaluated score of below 45 may be interpreted as a forecasted failure of the corporate strategy.

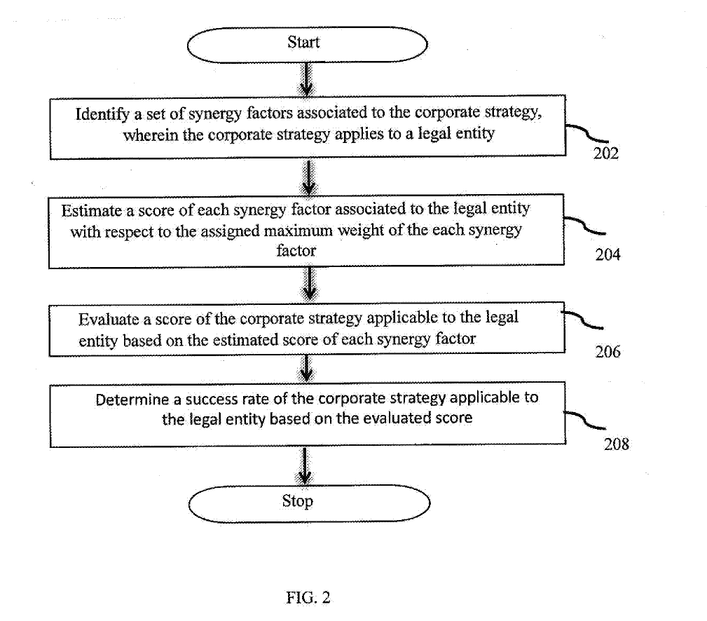

FIG. 2 discloses a flowchart illustrating a method for evaluating a corporate strategy, according to an embodiment of the present invention. At step 202, a set of synergy factors associated to the corporate strategy may be identified, wherein the corporate strategy applies to a legal entity. For example the corporate strategy may include a merger and acquisition of a primary legal entity with the legal entity, where the primary legal entity and the legal entity are stock exchange listed companies. Further, the set of synergy factors may include finance, technology, management, geography, and macro-economic variables. Further, at step 204, a score of each synergy factor associated to the legal entity maybe estimated with respect to an assigned maximum weight of the each synergy factor. Qualitative and quantitative information of the legal entity may be retrieved from a cloud network to estimate the score of the each synergy factor. For example, the qualitative and quantitative information such as a performance data, geographical location, financial data, non-financial data and an industry sector associated with the legal entity. Furthermore, at step 206, a score of the corporate strategy applicable to the legal entity may be evaluated based on the estimated score of each synergy factor, and at step 208, a success rate of the corporate strategy applicable to the legal entity may be determined based on the evaluated score.

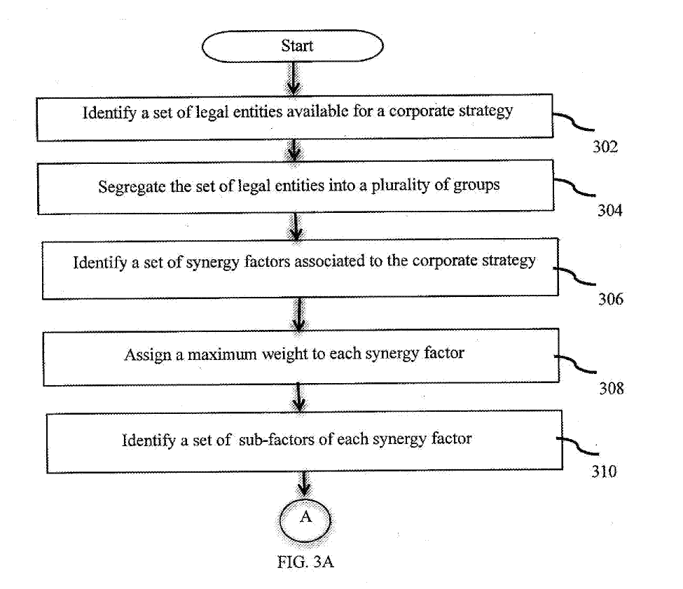

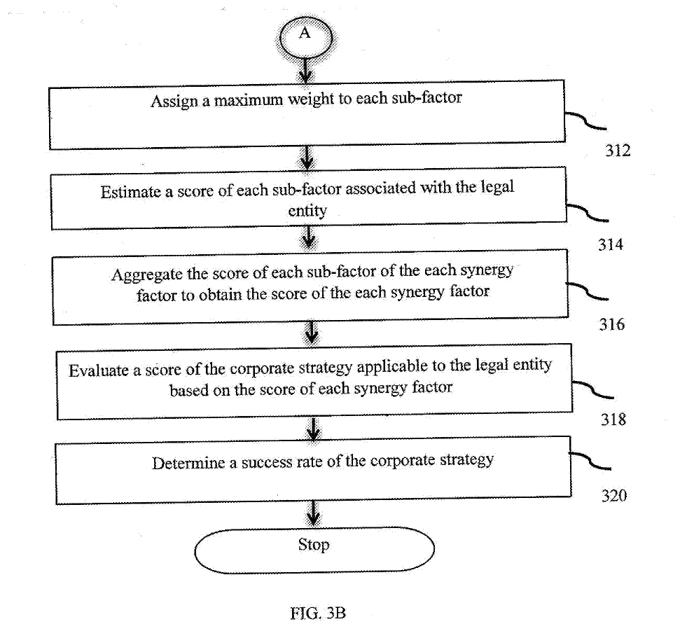

FIG. 3 disclosed another example flowchart illustrating a method for evaluating a corporate strategy for a primary legal entity in a data network. At step 302, a set of legal entities maybe identified for the corporate strategy with the primary legal entity. For example, the corporate strategy may include a merger and acquisition between the primary legal entity and a legal entity selected from the set of legal entities. Further at step 304, the set of legal entities may be segregated into a plurality of groups based on a type and market capitalization of the legal entity. For example, a legal entity may be segregated as a large cap entity if its market capitalization is greater than a market determined threshold. Further, at step 306, a set of synergy factors associated to the corporate strategy maybe identified. For example, the set of synergy factors may include finance, technology, management, geography, and macro-economic variables. Further at step 308, a maximum weight may be assigned to each synergy factor and a set of sub-factors maybe identified for each synergy factor at step 310.

Furthermore, at step 312, a maximum weight to each sub-factor maybe assigned. Further at step 314, a score of each sub-factor associated with the legal entity maybe estimated. For example, a sub-factor such as Multiple—EV/EBITDA of the finance synergy factor may be assigned a maximum weight of 4. Further, a score of ‘1’ may be assigned for said sub-factor if value of the Multiple—EV/EBITDA of the legal entity falls within ‘0 to 5’, a score of ‘2’ may be assigned to said sub-factor if value of the sub-factor falls within ‘5-10’, a score of ‘3’ may be assigned to said sub-factor when value of the sub-factor of the legal entity is between ‘10-20’, and a score of ‘4’ may be assigned to said sub-factor when value of the sub-factor of the legal entity is between ‘20-30’.

In another example, for the technology synergy factor a maximum weight of 20 may be assigned. A set of ten sub-factors such as current technology, new technology, adaptability, patent, Research and Development (R&D), expense required, replacement cost, suitability, environment factors, and a life span of technology may be identified for the technology synergy factor. Further, each of aforesaid sub-factors may be assigned a maximum weight such as the sub-factor including environment factors may be assigned a maximum weight of 3. Furthermore, a scoring pattern for said sub-factor may be defined such as a score of ‘1’ may be attributed for the sub-factor associated with the legal entity, when the environment hazard caused by a legal entity is high, a score of ‘2’ may be attributed when the environment hazard caused by the legal entity is medium, and a maximum score of ‘3’ may be attributed when the environment hazard caused by the legal entity is low or nil.

Further, the score of each sub-factor of the each synergy factor may be aggregated at step 316, to obtain the score of the each synergy factor. Further, at step 318, a score of the corporate strategy applicable to the legal entity maybe evaluated based on the score of each synergy factor. For example, the score of each synergy factor may be summed to obtain the score of the corporate strategy applicable to the legal entity. Based on the evaluated score a success rate of the corporate strategy maybe determined at step 320. For example a predetermined threshold for the evaluated score may be incorporated to determine the success rate. In an event where the evaluated score is greater than the predetermined threshold, the success rate may be considered to be high which indicates a merger and acquisition with corresponding legal entity may prove successful. Alternately, in an event where the evaluated sore is lower that the predetermined threshold, the success rate may be interpreted to be low which indicates the corporate strategy with the corresponding legal entity may result in a failure.

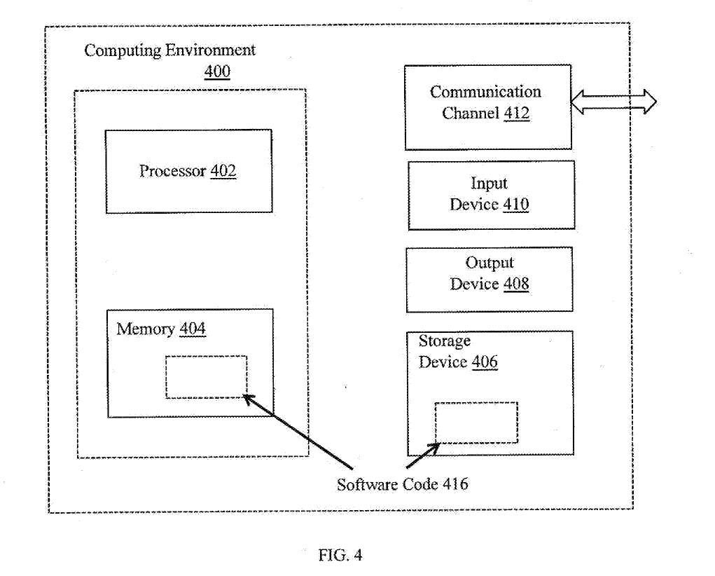

FIG. 4 illustrates a generalized example of a computing environment 400. The computing environment 400 is not illustrated to include any limitation within a scope of use or functionality of various embodiments described in the present invention.

With reference to FIG. 4, the computing environment 400 shall include preliminary components, such as at least one processor 402 and a memory 404. The processor 402 can be a real or a virtual processor that executes computer readable instructions. A multi-processing system shall include multiple processors that execute computer readable instructions, for increasing a processing power. The memory 404 can be a volatile memory viz. registers, cache, or a RAM; or a non-volatile memory viz. ROM, EEPROM, flash memory, and the like, or a combination of the volatile memory and the non-volatile memory. In some embodiments, the memory 404 shall store a software code 416 that embodies functionality and techniques of the present invention.

In an instance the computing environment 400, may include additional components, such as one or more storage device 406, one or more input device 410, one or more output device 408, and one or more communication channel 412. In an embodiment, an interconnection mechanism such as a bus, controller, or a network, can interconnect the additional components of the computing environment 400. Typically, an operating system provides an operating environment for running the software code 416, within the computing environment 400, and for coordinating activities of the preliminary components and the additional components of the computing environment 400.

The storage device 406, can include one or more removable or non-removable, electronic devices. Instances of the storage device 406 include a magnetic disk, a magnetic tape, a cassette, a CD-ROM, a CD-RW, a DVD, or any other medium which can be used to store information and which can be accessed within the computing environment 400. In some embodiments, the storage 416 stores instructions for the software code 416.

The input device 410 can be a touch input device such as a keyboard, mouse, pen, a trackball, a touch screen, a voice input device, a scanning device, a digital camera, or any other device that provides input to the computing environment 400. The output device 408 can be a video display, a printer, a speaker, or another device that provides output from the computing environment 400.

The communication channel 412 enables communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, the communication medium can include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include the memory 404, the storage device 406, the communication media, and combinations of any of the above.

Having described and illustrated the principles of the present invention with reference to described embodiments, it shall be recognized that the described embodiments can be modified in arrangement and detail without departing from the principles. It should be understood that the system, processes, methods or computer program products, as described herein are not related or limited to any particular type of computing environment, unless indicated otherwise. A plurality of general purpose or specialized computing environments may be used with or perform operations in accordance with the techniques of the present invention. Elements of the described embodiments as included in the software code 416, shall be implemented in hardware and vice versa. As will be appreciated by those ordinary skilled in the art, the foregoing example, demonstrations, and method steps may be implemented by suitable code on a processor base system, such as general purpose or special purpose computer.

The techniques, computer program products, methods, processes, and system, as described in present description, herein include a preferred embodiment for carrying out the present invention. Various modifications to the preferred embodiment can be readily apparent to those skilled in the art and some features of the present invention may be used without the corresponding use of other features. Accordingly, the present invention is not intended to be limited to the embodiment shown but is to be accorded the widest scope consistent with the principles and features described herein. The present description has been intended for a purpose of obtaining a patent. It is further, intended by following claims to cover the various embodiments, modifications, and variations that may fall within a scope of subject matter described.

We claim:

1. A system for evaluating a corporate strategy in a data network, the system comprising:
a network server configured to identify a set of legal entities applicable to the corporate strategy; and
a computing device in communication with the network server, the computing device comprising a prediction engine configured to:
identify a set of synergy factors associated to the corporate strategy,
estimate a score of each synergy factor associated to a legal entity with respect to the assigned maximum weight of the each synergy factor, wherein the legal entity is selected from the set of legal entities,
evaluate a score for the corporate strategy applicable to the legal entity based on the estimated score of each synergy factor, and
determine a success rate of the corporate strategy applicable to the legal entity based on the evaluated score.

2. The system of claim 1, wherein the computing device further comprises:
a user interface unit configured to receive an input of evaluating the corporate strategy between a primary legal entity and the legal entity; and
a communication unit configured to:
retrieve the set of legal entities from the network server via a communication link, and
segregate the set of legal entities into a plurality of groups based on a type and market capitalization of the legal entity.

3. The system of claim 2, wherein the corporate strategy comprises a merger and acquisition of the primary legal entity with the legal entity.

4. The system of claim 1, wherein the set of synergy factors comprise finance, technology, management, geography, and macro-economic variables.

5. The system of claim 2, wherein the prediction engine is further configured to:
assign a maximum weight to each synergy factor;
identify a set of sub-factors of each synergy factor;
assign a maximum weight to each sub-factor;
estimate a score of each sub-factor associated with the legal entity based on the assigned maximum weight of the each sub-factor and one of a performance data, geographical location, financial data, non-financial data and the group of the legal entity; and
aggregate the score of each sub-factor of the synergy factor to obtain the score of the synergy factor.

6. The system of claim 5, wherein the communication unit is further configured to:
retrieve the one of the performance data, the geographical location, financial data, non-financial data of the legal entity from the network server.

7. A method for evaluating a corporate strategy in a data network, the method comprising:
identifying a set of synergy factors associated to the corporate strategy, wherein the corporate strategy applies to a legal entity;
estimating a score of each synergy factor associated to the legal entity with respect to the assigned maximum weight of the each synergy factor;
evaluating a score of the corporate strategy applicable to the legal entity based on the estimated score of each synergy factor; and
determining a success rate of the corporate strategy applicable to the legal entity based on the evaluated score.

8. The method of claim 7, further comprising:
identifying a set of legal entities available for the corporate strategy;
segregating the set of legal entities into a plurality of groups, based on a type and a market capitalization of the legal entity; and
assigning a maximum weight to each synergy factor.

9. The method of claim 7, wherein the corporate strategy comprises a merger and acquisition of a primary legal entity with the legal entity.

10. The method of claim 7, wherein the set of synergy factors comprise finance, technology, management, geography, and macro-economic variables.

11. The method of claim 8, wherein estimating a score for each synergy factor comprises:
identifying a set of sub-factors of each synergy factor;
assigning a maximum weight to each sub-factor;
estimating a score of each sub-factor associated with the legal entity based on the assigned maximum weight of the each sub-factor and one of a performance data, geographical location, financial data, non-financial data and the group associated with the legal entity; and
aggregating the score of each sub-factor of the each synergy factor to obtain the score of the each synergy factor.

12. The method of claim 11, further comprising:
retrieving the performance data, geographical location, financial data, non-financial data of the legal entity from a network server.

13. A non-transitory computer readable medium having stored thereon instructions for evaluating a corporate strategy in a data network which when executed by at least one processor, causes the processor to perform steps comprising:
identifying a set of synergy factors associated to the corporate strategy, wherein the corporate strategy applies to a legal entity;
assigning a maximum weight to each synergy factor;
estimating a score of each synergy factor associated to the legal entity with respect to the assigned maximum weight of the each synergy factor;
evaluating a score of the corporate strategy applicable to the legal entity based on the estimated score of each synergy factor; and
determining a success rate of the corporate strategy applicable to the legal entity based on the evaluated score.

14. The non-transitory computer readable medium of claim 13, causes the processor to perform steps further comprising:
identifying a set of legal entities available for the corporate strategy; and
segregating the set of legal entities into a plurality of groups, based on a type and a market capital of the legal entity.

15. The non-transitory computer readable medium of claim 13, wherein the corporate strategy comprises a merger and acquisition of a primary legal entity with the legal entity.
